(19) United States
(12) Patent Application Publication
(10) Pub. No.: US 2011/0040922 A1
(43) Pub. Date: Feb. 17, 2011

(54) INTERPOSING APPARATUS FOR HOT-PLUGGING DEVICE TESTING

(76) Inventor: Michael Dearman, Elgin (GB)

Correspondence Address: BUTZEL LONG;IP DOCKETING DEPT, 350 SOUTH MAIN STREET, SUITE 300, ANN ARBOR, MI, 48104, US

(21) Appl. No.: 12/864,635

(22) PCT Filed: Jan. 28, 2009
(86) PCT No.: PCT/GB2009/050080

§ 371 Date: Oct. 29, 2010

(30) Foreign Application Priority Data
Jan. 29, 2008 (GB) 0801533.1

(51) Int. Cl. G06F 13/00

(52) U.S. Cl. 710/316

(57) ABSTRACT

An apparatus adapted to interpose a first device and a second device for selective connection between the first device and the second device, each of the first device and the second device including a connector having a plurality of contacts, the apparatus comprising: a first plurality of contacts for connecting to the plurality of contacts of the first device; a second plurality of contacts for connecting to the plurality of contacts of the second device; and sequential switching means adapted to sequentially connect the plurality of contacts of the first device to the plurality of contacts of the second device.

The present invention relates to apparatus for connecting devices or components. In particular, the invention relates to apparatus which interposes two or more devices or components which are to be safely electrically connected, such as by “hot swapping”.

Electronic devices increasingly incorporate “hot swapping” or “hot plugging” capability, whereby users may remove and insert components of a system whilst it remains fully powered up and operational. These terms mean, in the least, that devices or components may be added or removed without powering down. The terms may also refer to the ability of the system to autonomously detect the addition or removal of hardware. The most well known example of hot swapping is the Universal Serial Bus (USB) which allows users to safely add and remove peripheral components to a computer without rebooting.

The devices are typically electrically connected using connectors with a staggered pin arrangement. For instance, the ground pins are longer than the other pins to ensure there is always grounding before power connection. One of the four corners of the connector will always make first physical contact. It is therefore common to arrange the ground pins at the corner, the power pin centrally and signal pins in between.

Conventional testing of hot swappable components is generally performed manually but, since devices must be physically added then removed a number of times, this is a slow process. There is also high variability as every hot swap operation is subtly different and dependent on the speed and manner that the component is inserted or removed by the operator. Which corners, and therefore pins, of the connector make first contact, and the elapsed time between further connection of power and signal pins, will vary each time a device is added or removed.

Furthermore, physical variations in the connectors arise from manufacturing variability and from degradation. In a connector housing two pins, the first pin may be microscopically shorter than the second pin in a first batch. However, in a second batch, the second pin may be shorter than the first. Consequently, without testing every individual connector, it is practically impossible to guarantee test coverage of a connector for all variations. Also, faults discovered under this test method are not easily repeatable, since testing is performed manually. This can lead to long lead times on bug fixes.

In addition, conventional testing involves either making or breaking the connection between devices. There is no ability to provide a different signal between devices to determine how a device copes with this different signal.

U.S. Pat. No. 6,782,442 discloses a robotic hot swap testing system which allows some control over the speed and manner of insertion and removal of a component. However, control errors as well as tolerances in the actuators, linkage and latching arrangement make it difficult to achieve accurate timing with a robotic system.

A test system comprising an interposer card with relays and a timing device is described in U.S. Pat. No. 6,704,827. This system uses a pair of relays to make and break the power connections between a host computer and a device. A timer circuit controls the cycle time of the relays. Individual connection and sequencing of the pins is not taught and is not possible using the disclosed apparatus. There is therefore a lack of precision in controlling connectivity and the ways in which a hot plug event may be simulated are limited.

Furthermore, contact bounce is a common problem with relays and sequential digital logic circuits are particularly vulnerable to contact bounce. In addition, the contact closure is limited by the inertia of the actuator within the relay, resulting in slow and nondeterministic switching times. However, a relay based test system does not allow the user to simulate the contact bounce between surfaces of the connectors, due to the slow switching times involved.

According to a first aspect of the present invention there is provided an apparatus adapted to interpose a first device and a second device to provide selective connection between the first device and the second device, each of the first device and the second device including a connector having a plurality of contacts, the apparatus comprising:
a first plurality of contacts for connecting to the plurality of contacts of the first device;
a second plurality of contacts for connecting to the plurality of contacts of the second device; and
sequential switching means adapted to sequentially connect the plurality of contacts of the first device to the plurality of contacts of the second device.

The apparatus may be adapted to provide selective electrical connection between the first device and the second device. Alternatively, the apparatus may be adapted to provide selective optical connection between the first device and the second device.

The apparatus may be an external adapter. The adapter may have a female socket for receiving the first device and a male socket for receiving the second device. Alternatively, the apparatus may be an internal component of one of the first device and the second device.

The first device may be a computer. The second device may be a peripheral device, such as a keyboard, mouse, monitor, printer, scanner, memory stick, PDA, mobile phone, camera, satellite navigation device or the like.

The connection protocol between the first device and the second device may be one of USB, PC card, FireWire™, Fibre Channel, SATA, SCSI and SAS.

The sequential switching means may comprise a switch controller and a plurality of switches. The switches may comprise analogue switches, such as bilateral analogue switches.

The sequential switching means may be adapted to utilize a plurality of sequences for connecting the plurality of contacts of the first device to the plurality of contacts of the second device.

The sequential switching means may be adapted to simulate contact bounce.

The apparatus may be adapted to provide a simulated signal to one or both of the first and second devices. One or more values of the simulated signal may be variable. The apparatus may be adapted to provide a simulated signal to individual contacts of one or both of the first and second devices.

The switch controller may comprise a microprocessor provided within the apparatus. Alternatively or in addition, the switch controller may comprise a programmable logic unit such as a PLC or FPGA.

Alternatively or in addition, the switch controller may comprise one of the first device and the second device. Alternatively or in addition, the switch controller may comprise a third device. The third device may comprise a controlling computer. Controller connection means may be provided between the apparatus and the first, second or third device. The controller connection means may comprise a flat cable.

The switch controller may include inputting means such as a Command Line Interface or a Graphic User Interface for defining or modifying the switching sequence. The controller may include outputting means for transmitting status information such as one or both of voltage and current measurements.

According to a second aspect of the present invention there is provided an apparatus adapted to interpose a first device and a second device to provide selective connection between the first device and the second device, each of the first device and the second device including a connector having a plurality of contacts, the apparatus comprising:
a first plurality of contacts for connecting to the plurality of contacts of the first device;
a second plurality of contacts for connecting to the plurality of contacts of the second device; and
analogue switching means adapted to connect the plurality of contacts of the first device to the plurality of contacts of the second device.

The apparatus may be adapted to provide selective electrical connection between the first device and the second device. Alternatively, the apparatus may be adapted to provide selective optical connection between the first device and the second device.

The apparatus may be an external adapter. The adapter may have a female socket for receiving the first device and a male socket for receiving the second device.

The first device may be a computer. The second device may be a peripheral device.

The analogue switching means may comprise a switch controller and a plurality of switches. The switches may comprise bilateral analogue switches.

The analogue switching means may comprise sequential switching means for sequentially connecting the plurality of contacts of the first device to the plurality of contacts of the second device.

The sequential switching means may be adapted to utilize a plurality of sequences for connecting the plurality of contacts of the first device to the plurality of contacts of the second device.

The sequential switching means may be adapted to simulate contact bounce.

The apparatus may be adapted to provide a simulated signal to one or both of the first and second devices. One or more values of the simulated signal may be variable. The apparatus may be adapted to provide a simulated signal to individual contacts of one or both of the first and second devices. Embodiments of the present invention will now be described, by way of example only, with reference to the accompanying drawings in which:

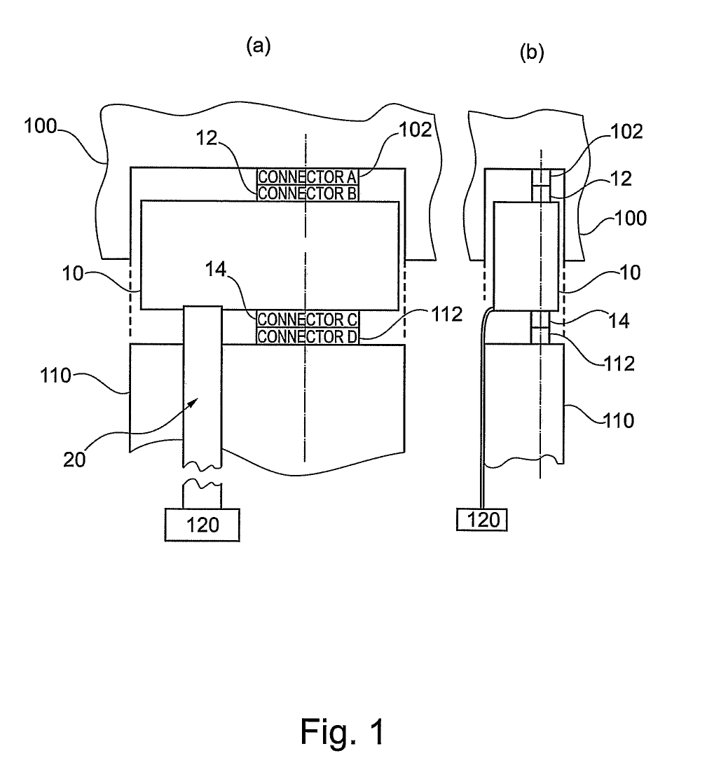

FIG. 1 is a (a) plan view and a (b) side view of an interposing apparatus connecting a first and second device;

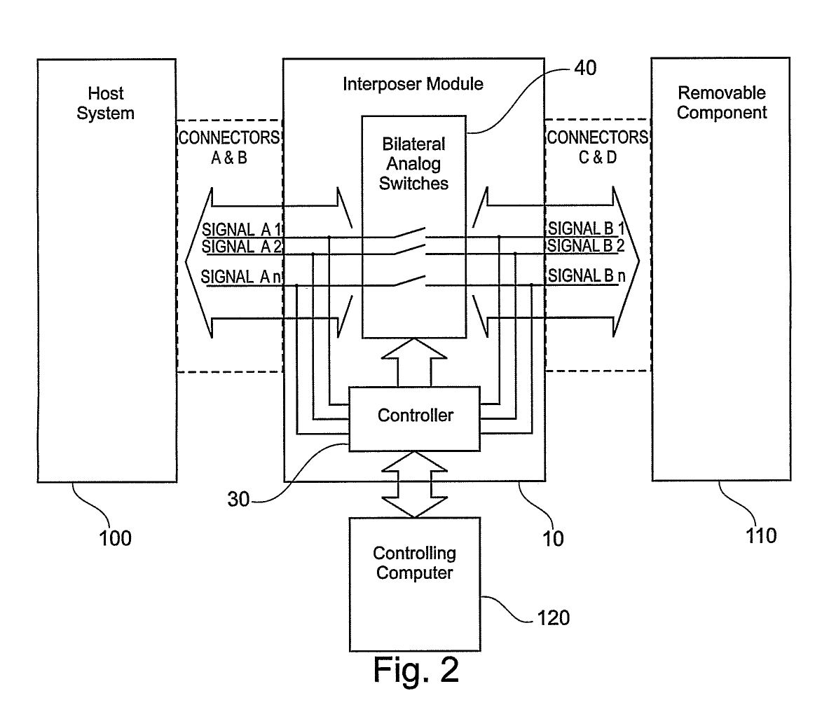

FIG. 2 is a system diagram for the interposing apparatus and first and second devices of FIG. 1;

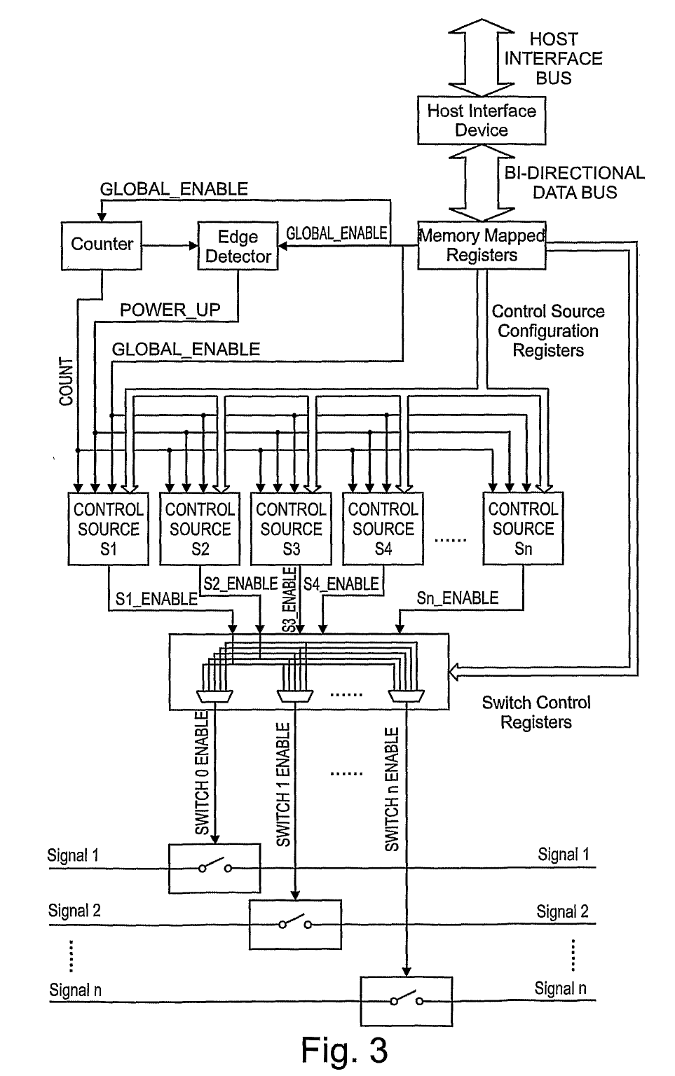

FIG. 3 is a block diagram for the interposing apparatus and first and second devices of FIG. 1;

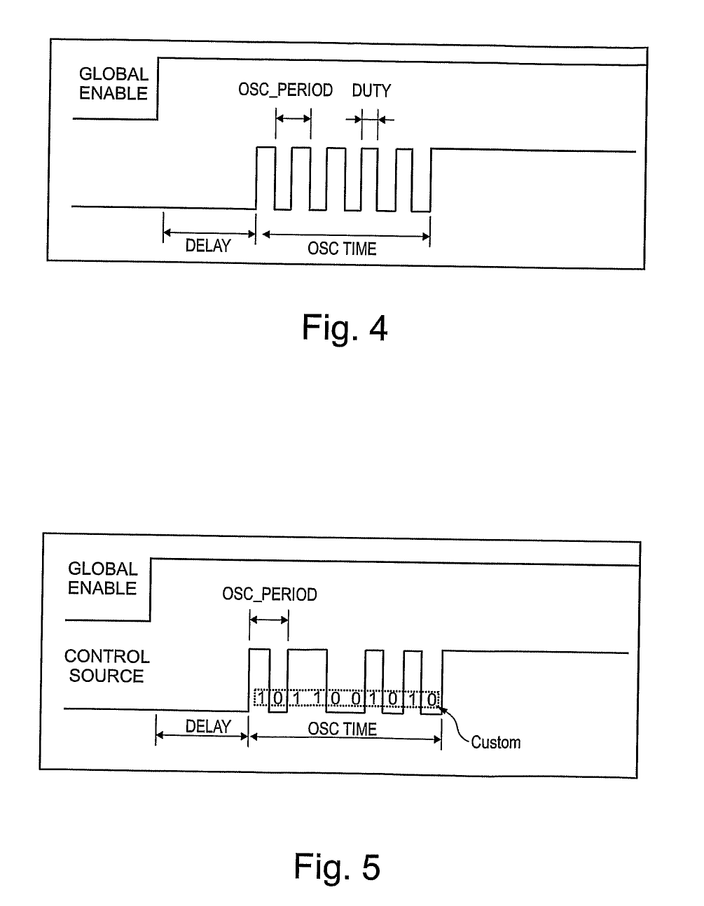

FIG. 4 is a frequency plot showing the parameters used when connecting the first and second devices using constant frequency

FIG. 5 is a frequency plot showing the parameters used when connecting the first and second devices using a custom variable frequency;

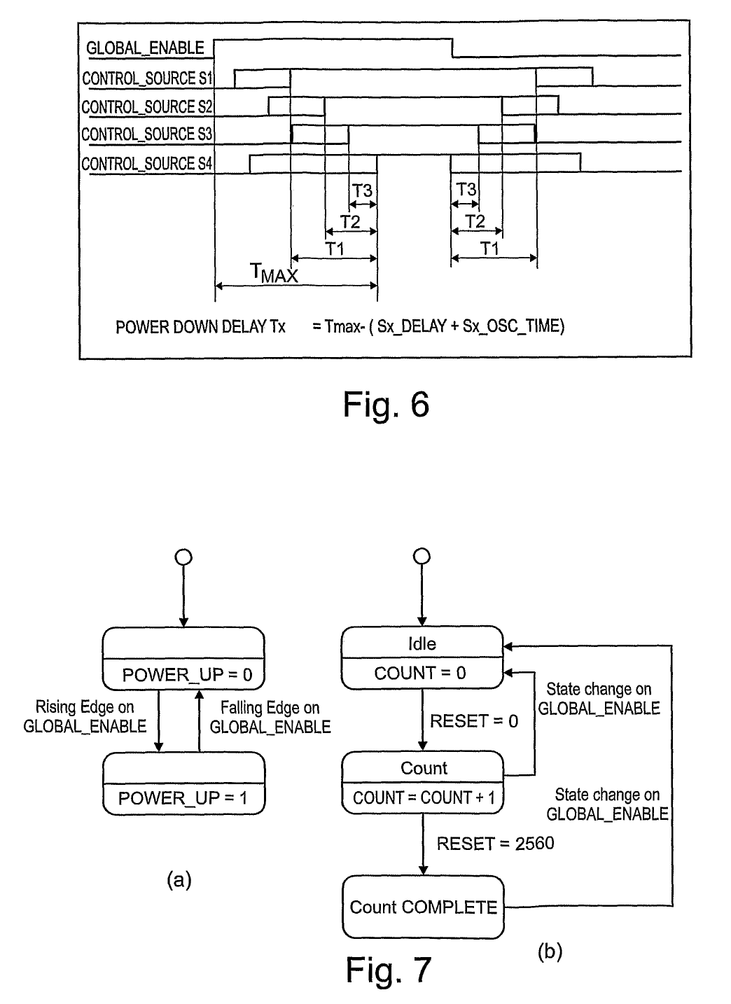

FIG. 6 is a time plot showing the timing used when connecting and disconnecting the first and second devices; and

FIG. 7 is a state diagram for (a) power up, and (b) count;

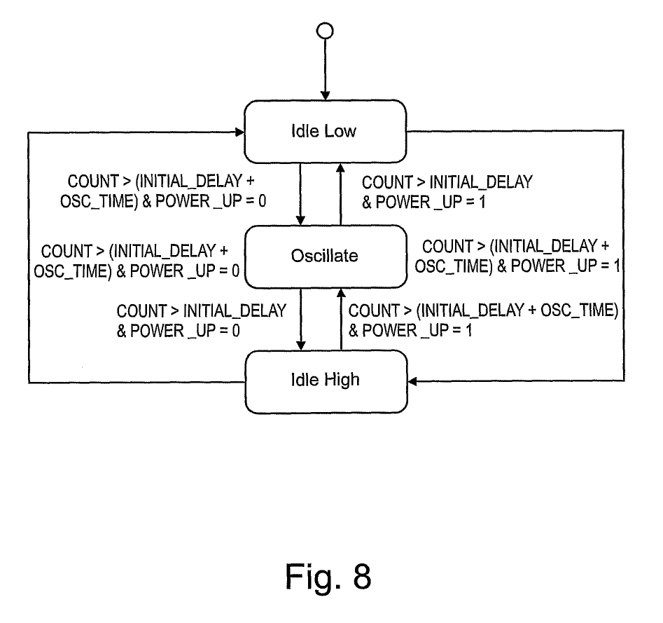

FIG. 8 is a state diagram for each control source; and

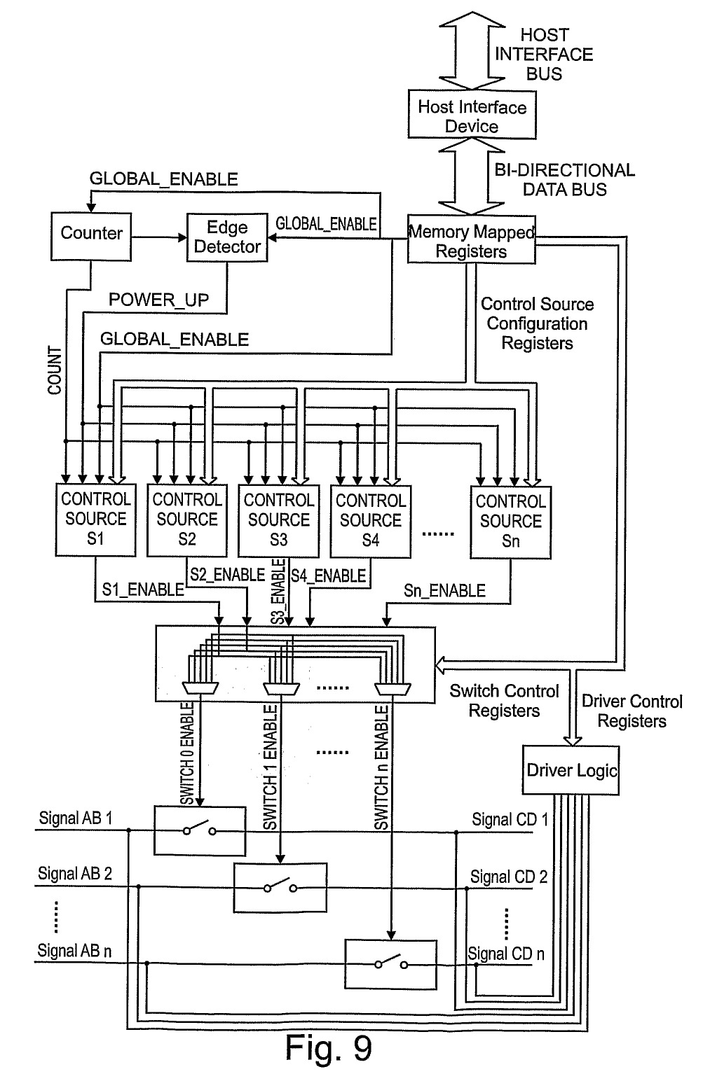

FIG. 9 is a block diagram for a second embodiment of the interposing apparatus and first and second devices of FIG. 1.

FIG. 1 shows an apparatus 10 adapted to interpose a first device or computer 100 and a second device or peripheral device 110 for selective electrical connection between the computer 100 and the peripheral device 110.

The computer 100 includes a female socket 102 having a plurality of contacts. The peripheral device 110 includes a male socket 112 having a plurality of contacts. The apparatus includes a male socket 12 having a first plurality of contacts for connecting to the socket 102 of the computer 100 and a female socket 14 having a second plurality of contacts for connecting to the socket 112 of the peripheral device 110. The computer 100, apparatus 10 and peripheral device 110 are therefore in-line with respective pins in a serial arrangement.

The dimensions of the apparatus 10 are adapted to be the same or slightly less than the dimensions of the computer socket 102 and the peripheral device 110. This ensures that the apparatus 10 and peripheral device 110 when mated together may still be inserted into the socket 102.

Controller connection means in the form of a very thin flexible cable 20 is used to connect the apparatus 10 to a controlling computer 120. A single sided flex circuit may be used to produce a cable of 0.005″ (0.135 mm) thickness. The cable runs along the top surface of the removable component and the gap between component and cavity must be large enough to allow this.

As shown in FIG. 2, the apparatus 10 also includes switching means comprising a switch controller 30 and a plurality of switches 40. The switch controller 30 is connected to the controlling computer 120. The switches 40 are bilateral analogue switches which provide a low impedance path when the switch 40 is on, and a high impedance when off. Analogue switches behave in a similar way to a relay but have no moving parts. They are therefore capable of much faster and deterministic switching while avoiding contact bounce.

The controller 30 may comprise a microprocessor provided within the apparatus. Alternatively or in addition, the controller may comprise a programmable logic unit such as a PLC or FPGA.

The apparatus 10 allows a user to set values for the mating time of each pin of the peripheral device 110 with the corresponding pin of the computer 100. In particular, the mating time may be set so that the pins mate sequentially. Various sequences are possible. This allows the simulation of a hot swapping event. Alternatively, one or more pins may be interrupted during system operation, by switching off the appropriate switch, in order to test system resiliency. In dual redundant systems, the apparatus 10 may be used to inject errors such as failure of communications busses between removable components. The apparatus 10 also allows the user to emulate contact bounce, as usually occurs when pins mate.

Logic functions are implemented using a single controller 30. The Host Interface may be implemented in a microcontroller with integrated or external bus transceivers for the chosen host interface. The Host Interface implements the transmission of data to and from the memory mapped registers, and monitoring of voltage and current on one or more signals in the interconnection between the computer 100 and peripheral device 110.

The Host Interface includes inputting means in the form of a command line interface. A Graphic User Interface for defining or modifying the switching sequence may be implemented in software on the controlling computer 120.

The apparatus 10 is controlled through the Host Interface by setting parameters individually for each Control Source, and assigning each switch 40 to a Control Source through the register map.

Referring to FIG. 3, a hot swap event is initiated by toggling the GLOBAL_ENABLE bit in the control register. A low to high transition on GLOBAL_ENABLE initiates a power up operation and a high to low transition initiates a power down operation. Further transitions that occur on GLOBAL_ENABLE will trigger a new operation regardless of the state of the apparatus 10 at that time. A BUSY bit within the control register indicates when an operation is in progress.

The control signal for each switch 40 is assigned to one of a number of Control Sources. For each Control Source, once a defined Delay period has elapsed after the transition on GLOBAL_ENABLE, the ENABLE output oscillates for a period of time before remaining at the new logic level.

Each Control Source has a separate set of configurable parameters.

The first parameter is the Oscillation Mode. In constant frequency mode, the Control Source will output a constant frequency square wave during oscillation. In custom pattern mode, the Control Source will output a user defined pattern during oscillation.

The second parameter is the Delay value, which is the initial delay before the Control Source begins to oscillate.

The third parameter is the Oscillation Time, which is the length of time that the output of the Control Source is oscillated before returning to a steady state.

The fourth parameter is the Oscillation Period, which is the time period between rising/falling edges during oscillation.

The fifth parameter is the Duty cycle of the output waveform during oscillation.

FIG. 4 shows the second to fifth parameters for a power up event in constant frequency mode. FIG. 5 shows the second to fifth parameters for a power up event in custom pattern mode. A typical power up and power down event is shown in FIG. 6.

Referring again to FIG. 3, each switch control input is either driven by a Control Source or set to a solid state, by assignment in the switch control registers.

Each Control Source is implemented as a state machine that decodes the parameter COUNT. This is a counter with a maximum value equal to the sum of the maximum Delay and the Oscillation Time values. COUNT is clocked by a constant frequency clock, derived from an external oscillator. The period of the clock source should be equal to the smallest unit of time configurable in the Delay or Oscillation Time registers.

Any transition on GLOBAL_ENABLE resets COUNT. When released from reset, COUNT increments to a maximum value. If at any time GLOBAL_ENABLE changes state, COUNT is reset and the sequence starts again. The POWER_UP signal indicates a power-up or power-down operation is taking place. A rising edge on GLOBAL_ENABLE sets signal POWER_UP=1, while a falling edge on GLOBAL_ENABLE sets POWER_UP=0.

FIG. 7 shows COUNT and POWER_UP state diagrams.

On power-up, a Control Source is in the idle low state, outputting a low level control signal and turning any assigned switches off. On a low to high transition of GLOBAL_ENABLE, COUNT is reset to zero and POWER_UP is set to 1. COUNT begins to increment, and when it reaches a value higher than DELAY, it enters the oscillate state. In the oscillate state, the output oscillates between low and high, with a pattern, frequency, and duty cycle as defined by the user. When COUNT increments to a value higher than both the Delay and Oscillation Time, the idle high state is entered and a steady high level is output, enabling the assigned switches.

Regarding the power-down operation, on a high to low transition of GLOBAL_ENABLE, COUNT is reset to zero and POWER_UP is set to 0. COUNT begins to increment, and when it reaches a value higher than DELAY, it enters the Oscillate state. In the Oscillate state the output oscillates between high and low, with a pattern, frequency and duty cycle as defined by the user. When COUNT increments to a value higher than both the Delay and Oscillation Time, the idle low state is entered and a steady low level is output, disabling the assigned switches.

FIG. 8 shows a control source state diagram.

The interposer module is typically controlled with an RS232 or USB interface, although any suitable electrical interface may be used that allows the user to send to and receive data from the module.

It should be noted that, since all Power up/down operations are initiated by toggling the single register bit GLOBAL_ENABLE, timing is always accurate regardless of bus timing/data rate. Any latency incurred in writing to the GLOBAL_ENABLE signal effects all operations equally.

Communication across the interface is handled by a command line interface which allows the user to send and receive data using read and write commands to write data to memory mapped registers on the controller card. Further commands allow the user to upgrade card firmware or retrieve voltage and current measurements.

As shown in FIG. 3, each Control Source is configured by a separate set of memory mapped registers. Typically, eight-bit wide registers are used, but higher levels of precision may be used.

A second embodiment of the invention is shown in FIG. 9. This is the same as before except for the inclusion of driver logic circuitry. As shown in FIG. 9, tri-state driver circuitry is connected to both sides of each bilateral analog switch, although connection to only one side may be sufficient for some testing requirements. The tri-state driver may be used to drive the signal with external stimulus whilst the bilateral analog switch isolates the signal from the existing driver.

This embodiment allows isolation of a signal from its original driver and enables the user to apply external stimulus to a selected part of an interconnect rather than the whole device, as would previously have been required. A large interconnect may contain hundreds of pins. If a user wishes to drive a small number of these with an external stimulus, they would traditionally have had to connect apparatus to control all of the pins, not just the few of interest.

This embodiment allows testing beyond simply making or breaking certain connections. Instead of causing no signal at a particular connection, an artificial signal can be sent to the particular connection. This artificial signal can be set to have a different value, such as for current, voltage or the like, than the actual signal when connection is made. There is no disruption to the rest of the system. This provides more sophisticated testing of system resiliency.

The present invention allows the independent connection of individual pins of the computer to the corresponding pin of the peripheral device. This allows the simulation of any conceivable hot swapping event. The use of user programmable test patterns increases flexibility. Therefore, any connector geometry, regardless of the physical properties of the connector, can be simulated.

Due to the use of solid state switching, the result of a particular hot swap simulation is repeatable. Problems with mechanical connector bounce and non-deterministic delays are eliminated. However, the simulation of connector bounce, as well as intermittent fault conditions, can be performed.

The module may be controlled remotely and by automated script. This allows the user to rapidly perform a series of tests in different configurations without user intervention.

The present invention also allows testing for system resiliency. The invention may be applied to any situation involving a separable electrical connection between two systems, where the user is investigating the effects of contact sequencing or failure of an individual or combination of signals.

Whilst specific embodiments of the present invention have been described above, it will be appreciated that departures from the described embodiments may still fall within the scope of the present invention.

1. An apparatus adapted to interpose a first device and a second device to provide selective connection between the first device and the second device, each of the first device and the second device including a connector having a plurality of contacts, the apparatus comprising:
a first plurality of contacts for connecting to the plurality of contacts of the first device;
a second plurality of contacts for connecting to the plurality of contacts of the second device; and
sequential switching means adapted to sequentially connect the plurality of contacts of the first device to the plurality of contacts of the second device.

2. An apparatus as claimed in claim 1, wherein the apparatus is adapted to provide selective electrical connection between the first device and the second device.

3. An apparatus as claimed in claim 1, wherein the apparatus comprises an external adapter having a female socket for receiving the first device and a male socket for receiving the second device.

4. An apparatus as claimed in claim 1, wherein the apparatus comprises an internal component of one of the first device and the second device.

5. An apparatus as claimed in claim 1, wherein the first device is a computer and wherein the second device is a peripheral device.

6. An apparatus as claimed in claim 1, wherein the sequential switching means comprises a switch controller and a plurality of switches.

7. An apparatus as claimed in claim 6, wherein at least one switch comprises an analogue switch.

8. An apparatus as claimed in claim 1, wherein the sequential switching means is adapted to utilize a plurality of sequences for connecting the plurality of contacts of the first device to the plurality of contacts of the second device.

9. An apparatus as claimed in claim 1, wherein the sequential switching means is adapted to simulate contact bounce.

10. An apparatus as claimed in claim 1, wherein the apparatus is adapted to provide a simulated signal to at least one of the first and second devices.

11. An apparatus as claimed in claim 10, wherein at least one value of the simulated signal is variable.

12. An apparatus as claimed in claim 10, wherein the apparatus is adapted to provide a simulated signal to individual contacts of at least one of the first and second devices.

13. An apparatus as claimed in claim 6, wherein the switch controller comprises a microprocessor provided within the apparatus.

14. An apparatus as claimed in claim 6, wherein the switch controller comprises one of the first device and the second device.

15. An apparatus as claimed in claim 6, wherein the switch controller comprises a third device.

16. An apparatus as claimed in claim 15, wherein controller connection means is provided between the apparatus and one of the group of the first, second and third devices.

17. An apparatus as claimed in claim 16, wherein the controller connection means comprises a flat cable.

18. An apparatus as claimed in claim 1, including inputting means for defining or modifying the switching sequence.

19. An apparatus as claimed in claim 1, including outputting means for transmitting status information.

20. An apparatus adapted to interpose a first device and a second device to provide selective connection between the first device and the second device, each of the first device and the second device including a connector having a plurality of contacts, the apparatus comprising:
a first plurality of contacts for connecting to the plurality of contacts of the first device;
a second plurality of contacts for connecting to the plurality of contacts of the second device; and
analogue switching means adapted to connect the plurality of contacts of the first device to the plurality of contacts of the second device.

21. An apparatus as claimed in claim 20, wherein the apparatus is adapted to provide selective electrical connection between the first device and the second device.

22. An apparatus as claimed in claim 20, wherein the analogue switching means comprises a switch controller and a plurality of switches.

23. An apparatus as claimed in claim 22, wherein the switches comprise bilateral analogue switches.

24. An apparatus as claimed in claim 20, wherein the analogue switching means comprises sequential switching means for sequentially connecting the plurality of contacts of the first device to the plurality of contacts of the second device.
